(19) United States
(12) Patent Application Publication
(10) Pub. No.: US 2009/0300487 A1
(43) Pub. Date: Dec. 3, 2009

(54) DIFFERENCE ONLY DOCUMENT SEGMENT QUALITY CHECKER

(75) Inventors: Kristin M. Hazlewood, Austin, TX (US); Bill Coltin, Austin, TX (US); John M. McConaughy, Austin, TX (US)

Correspondence Address: IBM CORPORATION (ACCSP);c/o Suiter Swantz pc llo, 14301 FNB Parkway, Suite 220, Omaha, NE, 68154, US

(73) Assignee: INTERNATIONAL BUSINESS MACHINES CORPORATION, Armonk, NY (US)

(21) Appl. No.: 12/127,430

(22) Filed: May 27, 2008

(51) Int. Cl. G06F 17/21

(52) U.S. Cl. 715/257

(57) ABSTRACT

A system and method for checking an author's revisions to a document or an electronic communication in a multiple party communication string without checking un-authored text.

### TECHNICAL FIELD

The present invention generally relates to the field of document checking and more particularly to a document utility capable of selectively allowing authors the option of either checking only a portion of a document changed from a previous point in time or checking only those portions of a document original to a particular author.

### BACKGROUND

When responding to an email, in the body of the text of the original email, spell checkers force users to check the spelling of the original text in addition to any newly updated text. This takes time and increases the level of tedium since the email author is likely not concerned with the spelling of previous emails contained within an email string.

Further, in other instances of shared document communication or preparation, where multiple authors are involved, authors should be provided the convenience and utility associated with a system capable of providing authors the option of only checking the accuracy of their authorship. This reduces document/communication time and prevents authors from making non-substantive changes to other author's writings. Additionally, it places the responsibility of accuracy on each author.

### SUMMARY

When an email or document is opened for update, the original text of the document or email is preserved so a spell check request can utilize a difference of the original document and the changes. Thus, only freshly or newly modified, or modified since, portions are analyzed. In one embodiment the text checking tool performs a difference spell check (newly changed and/or added text). It will be recognized that the present invention may be utilized with any text checking utility, e.g., grammar and the like checkers.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

The numerous advantages of the disclosure may be better understood by those skilled in the art by reference to the accompanying figures in which:

FIG. 1 is a diagrammatic illustration of the system of the present invention;

FIG. 2 is a block diagram of the system of the present invention; and

FIG. 3 is a block diagram of the method of the present invention.

### DETAILED DESCRIPTION

Reference will now be made in detail to the subject matter disclosed, which is illustrated in the accompanying drawings.

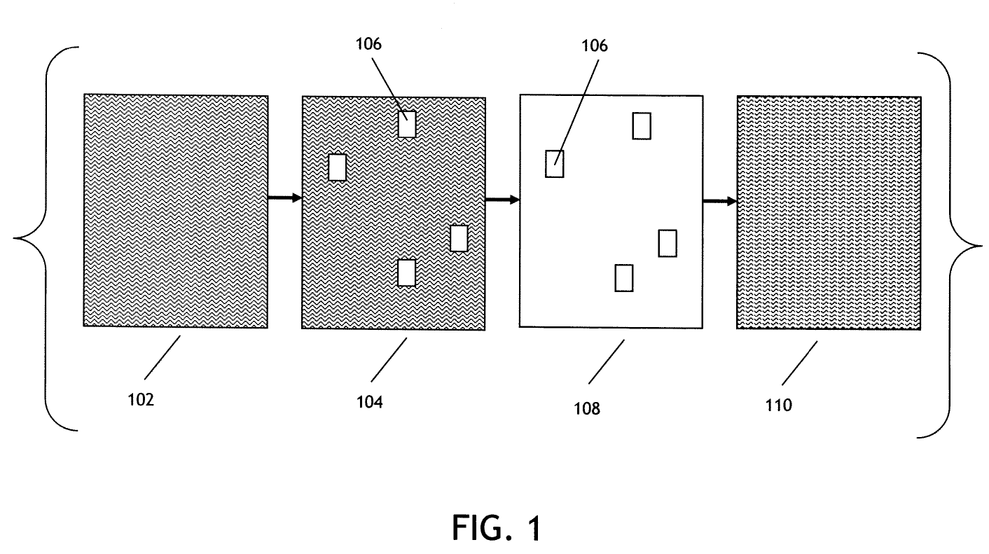

In operation, the system of the present invention, as illustrated in FIG. 1, allows for selectively text checking newly made or last open/read made changes, or changes made since a user selectable time, to a document having multiple saves, each associated with a text check, or multiple authors. A document 102 is read and displayed for edit or addition to an author. An author may comment, add, or edit the document 102 such that an edited document 104 is produced. The edited document 104 contains new, edited, added, or changed text portions 106. The set comprising the original document and the difference (edited document 104) may be text checked in accordance with known text checking methodologies and devices. However, said known text checking methodologies will text check the entire edited document 104 regardless of whether the document 102 has already been text checked. The present invention will check only the difference document 108 which consists of only the new, edited, added, or changed text portions 106. Once text checked, the present invention allows a user to accept any changes and produce a new document 110.

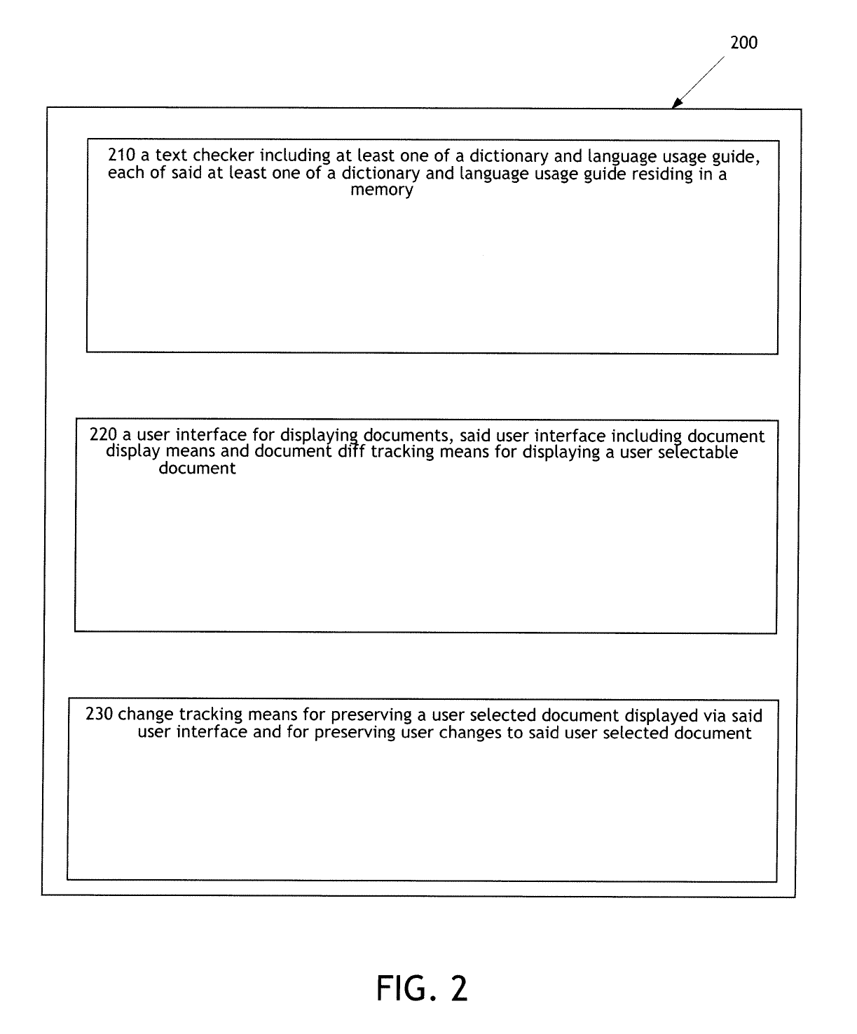

Referring now to FIG. 2, a document difference text checking system 200 is illustrated. The system 200 includes a text checker 210. The text checker 210 may include at least one of a dictionary and language usage guide. The dictionary and/or the language usage guide may reside in a memory. Further, the system 200 includes a user interface 220. The user interface 220 may display documents and may include document display means and document difference tracking means for displaying a user selectable document. Further, the system 200 includes change tracking means 230. The change tracking means 230 may be utilized for preserving a user selected document displayed via the user interface and for preserving user changes to the user selected document.

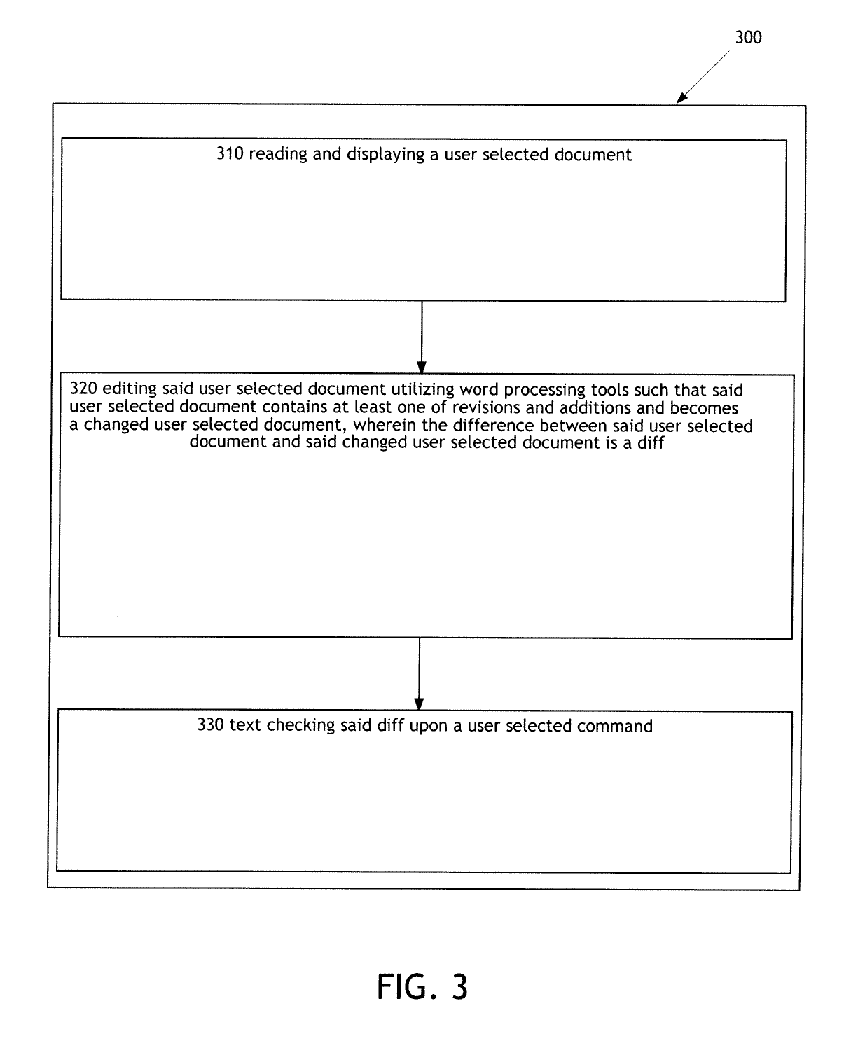

FIG. 3 illustrates an operational flow 300. After a start operation, the operational flow 300 moves to an operation 310. Operation 310 depicts reading and displaying a user selected document. Then, operation 320 depicts editing the user selected document utilizing word processing tools such that the user selected document contains at least one of revisions and additions and becomes a changed user selected document, wherein the difference between the user selected document and the changed user selected document is a difference. Then, operation 330 depicts text checking the difference upon a user selected command.

Text checking devices including spell and grammar checkers may be employed by the present invention. In operation, for example, a document prepared by another may include a marker indicating the document's text check status, i.e., checked or not checked, what portions have been checked, what portions have not been checked (including visual indication means), spelling only, grammar and spelling only or the like. A document to be altered is preserved as opened (received) and the edit difference is text checked upon user request or user selectable automatically checked prior to sending saving. A menu may be employed allowing a user optionally to not check unauthored portions or the like.

The present invention may also be utilized to text check only those portions of a document that have changed since a previous text check or edit. Thus, under this secondary embodiment the text check may be selectively employed after a point in time regardless of the number of authors or changes made in a time interval. In this fashion, where an author changes a document on Monday and sends the document out for collaboration, and where the document returns with other author input (changes) on Thursday, and the original author makes changes on that Thursday, the present invention may allow the original author to selectively text check back to a specific point in time, e.g., Monday.

In the present disclosure, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

1. (canceled)

2. A method of difference text checking a document, comprising:
reading and displaying a user selected document;
receiving an unauthored selection, wherein said unauthored selection indicates at least a portion of said user selected document that was not authored by a current user;
editing said user selected document utilizing word processing tools such that said user selected document contains at least one of revisions and additions and becomes a changed user selected document, wherein there is a difference between said user selected document and said changed user selected document including at least one of said revisions and said additions; and
text checking said difference and at least a portion of said user selected document excluding said unauthored selection upon a user selected command.
